(19) United States
(12) Patent Application Publication
(10) Pub. No.: US 2024/0231844 A1
(43) Pub. Date: Jul. 11, 2024

(54) CONTROL SYSTEM AND METHOD FOR CONTROLLING MEASUREMENT PROCESSING

(71) Applicant: Hitachi, Ltd., Tokyo (JP)

(72) Inventors: Mineyoshi MASUDA, Tokyo (JP); Koichi MURAYAMA, Tokyo (JP)

(21) Appl. No.: 18/522,965

(22) Filed: Nov. 29, 2023

(30) Foreign Application Priority Data
Jan. 11, 2023 (JP) 2023-002262

(51) Int. Cl. G06F 9/445

(52) U.S. Cl. CPC G06F 9/44505

(57) ABSTRACT

Provided is a simple method for performing control so that a measurement load caused by detailed measurement does not degrade performance of an application in accordance with a situation in which the detailed measurement is requested. A control system is connected to a computer system in which one or more hosts that execute processes constituting an application run, and manages a control policy for controlling, according to a load state of the host, execution of measurement processing for acquiring internal information on the host. The control system determines a control policy to be applied when a measurement request is received, and controls, based on the determined control policy and the load state of the host to be measured, execution of the measurement processing for the host to be measured.

### CLAIM OF PRIORITY

The present application claims priority from Japanese patent application JP 2023-002262 filed on Jan. 11, 2023, the content of which is hereby incorporated by reference into this application.

### BACKGROUND OF THE INVENTION

### 1. Field of the Invention

The present invention relates to a system and a method for supporting an IT system operation management task.

### 2. Description of Related Art

When a problem occurs in an IT system, detailed measurement is performed to investigate a cause of the problem. For example, measurement commands such as BCC and bpftrace utilizing the kernel tracing technique BPF are executed for a suspected computer suspected of a failure among computers constituting the IT system, and statistical information obtained by measuring an inside of the computer in detail is obtained. The cause of the problem can be promptly specified by analyzing the obtained statistical information.

When performing the detailed measurement, it is necessary to pay attention to a processing load of the detailed measurement. For example, when a measurement command is executed using the BPF in order to measure statistical information of I/O processing and system calls executed several million times per second, a large amount of CPU and memory may be consumed. Therefore, in particular, the detailed measurement in a production environment must be performed carefully so that the performance of an application running in the production environment does not degrade by resource consumption due to the detailed measurement.

A technique in the related art for automatically performing detailed measurement when a failure occurs is disclosed in, for example, PTL 1. PTL 1 discloses a technique of measuring a network flow in a network device. In a normal time, that is, when no problem occurs, not all the network flows but a part of the network flows are sampled and measured. When the measured network flow is inspected and some abnormality is detected, all the network flows are measured and inspected (corresponding to the detailed measurement). It is also disclosed that when abnormality is recognized in the performance of the network device, the measurement of the network flow is reduced conversely and a load on the network device is reduced (the measurement load is reduced).

### CITATION LIST

### Patent Literature

PTL 1: US2015/0074258

### SUMMARY OF THE INVENTION

The detailed measurement is mainly performed to investigate a problem occurring in an application in a production environment, and will be executed in more various situations in the future. Examples of the situations are as follows.
(1) A cause of a performance problem and an error occurring in an application under development is specified. (2) In a test environment close to the production environment, the detailed measurement is performed on old and new versions of applications, and the results are compared to confirm that the performance degradation does not occur before and after the update.
(3) The presence or absence of performance degradation is checked immediately after an application is updated to a new version in the production environment.
(4) Detailed measurement (sampling measurement) is performed when a service level of an application is in various good or bad states (for example, when the response time is normal, when the response time is slightly bad, or the like), and the result is used as a comparison target when some problems occur later.
(5) An application has different performance characteristics when workloads are different. Therefore, while various types of workloads are being executed (for example, online transactions, and high-load batch processing), detailed measurement is performed to grasp respective performance characteristics.

In this way, the detailed measurement is executed in various situations. Whether there is a situation in which performance degradation of an application due to an increase in a processing load of detailed measurement is required to be paid attention, and the degree to which attention is required to be paid vary depending on the situation.

For example, the situations (1) and (2) are detailed measurement in an environment other than the production environment, and therefore, it is not necessary to pay attention to the processing load of the detailed measurement in principle.

On the other hand, the situation (3) is detailed measurement in the production environment, and therefore, sufficient attention is required. In the situation (4), it is necessary to execute the detailed measurement at a timing at which the detailed measurement is requested, and therefore, execution control is required which does not delay the execution of the detailed measurement as much as possible while paying attention to the measurement load. In the situation (5), when the workload of the application is an online transaction, the influence of the measurement load on response time of the application is large, and therefore, it is particularly necessary to pay attention to the measurement load. On the other hand, when the workload of the application is batch processing, a high-load state often continues for a long time, and the influence of a temporary measurement load is not so critical. In this way, it is necessary to control the execution of the detailed measurement according to the situations.

An object of the invention is to provide a method for controlling execution of detailed measurement according to a situation.

A representative example of the invention disclosed in the present application is as follows. That is, provided is a control system connected to a computer system including a plurality of computers. One or more hosts configured to execute processes constituting an application run in the computer system. The control system manages a control policy for controlling, according to a load state of the host, execution of measurement processing for acquiring internal information on the host, determines a control policy to be applied when a measurement request is received, and controls, based on the determined control policy and the load state of the host to be measured, execution of the measurement processing for the host to be measured.

According to the invention, execution of detailed measurement can be controlled according to a situation. The problems, configurations, and effects other than those described above will become apparent in the following description of embodiments.

### BRIEF DESCRIPTION OF THE DRAWINGS

FIG. 1 is a diagram showing an outline of the invention;

FIG. 2 is a diagram showing an outline of the invention;

FIG. 3 is a diagram showing an example of a configuration of a system according to Embodiment 1;

FIG. 4 is a diagram showing an example of a data structure of control policy information according to Embodiment 1;

FIG. 5 is a diagram showing an example of a data structure of operation management service information according to Embodiment 1;

FIG. 6 is a diagram showing an example of a data structure of host information according to Embodiment 1;

FIG. 7 is a diagram showing an example of a data structure of application configuration information according to Embodiment 1;

FIG. 8 is a diagram showing an example of a data structure of measurement sequence information according to Embodiment 1;

FIG. 9 is a diagram showing an example of a data structure of measurement task information according to Embodiment 1;

FIG. 10 is a diagram showing an example of a data structure of service level measurement result information according to Embodiment 1;

FIG. 11 is a diagram showing an example of a data structure of workload information according to Embodiment 1;

FIG. 12 is a diagram showing an example of a data structure of execution condition information according to Embodiment 1;

FIG. 13 is a diagram showing an example of a data structure of service level reduction aggregation information according to Embodiment 1;

FIG. 14A is a flowchart showing an example of control policy setting processing executed by a measurement program according to Embodiment 1;

FIG. 14B is a flowchart showing an example of the control policy setting processing executed by the measurement program according to Embodiment 1;

FIG. 14C is a flowchart showing an example of the control policy setting processing executed by the measurement program according to Embodiment 1;

FIG. 15 is a flowchart showing an example of processing executed by the measurement program according to Embodiment 1;

FIG. 16A is a flowchart showing an example of execution timing control processing in detailed measurement executed by the measurement program according to Embodiment 1;

FIG. 16B is a flowchart showing an example of the execution timing control processing in the detailed measurement executed by the measurement program according to Embodiment 1;

FIG. 17 is a flowchart showing measurement command execution processing executed by the measurement program according to Embodiment 1;

FIG. 18 is a flowchart showing an example of check processing executed by the measurement program according to Embodiment 1; and

FIG. 19 is a flowchart showing an example of control level update processing executed by the measurement program according to Embodiment 1.

### DESCRIPTION OF EMBODIMENTS

Hereinafter, embodiments of the invention will be described with reference to the drawings. However, the invention is not to be construed as being limited to the contents described in the following embodiments. It will be easily understood by those skilled in the art that the specific configuration can be changed without departing from the spirit or scope of the invention.

In the configurations of the invention described below, the same or similar configurations or functions are denoted by the same reference signs, and redundant description will be omitted.

The notations “first”, “second”, “third”, and the like in the present specification and the like are provided to identify the components, and do not necessarily limit the number or the order thereof.

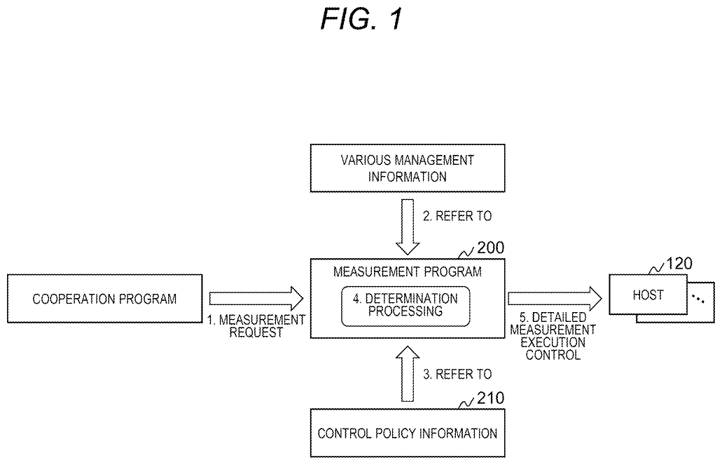

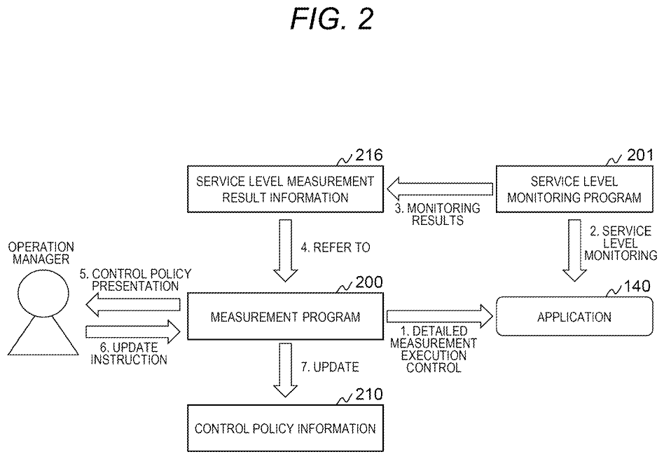

FIGS. 1 and 2 are diagrams showing an outline of the invention.

A measurement program 200 is a program for performing detailed measurement on a host 120 where an application operates. FIG. 1 shows an outline of processing in which the measurement program 200 selects a control level corresponding to a situation and controls execution of detailed measurement based on a control policy when performing the detailed measurement. The detailed measurement is defined as a sequence (measurement sequence) of a plurality of measurement commands.

The measurement program 200 receives an execution request (measurement request) of the detailed measurement, which includes a target application 140, a target host 120, and a type of the detailed measurement, from a cooperation program that provides an operation management service of an application. The measurement program 200 acquires information on an IT system (stage) where the target application 140 runs and a workload of the target application 140 that is operating. The measurement program 200 selects a control level corresponding to a situation and controls execution of detailed measurement according to the control level by referring to the control policy information 210.

The control level is an execution condition of a measurement command defined based on a processing load. Various control levels are set according to a degree to which the processing load is reduced.

That is, the measurement program 200 determines, based on the control level, whether the measurement command can be executed. That is, it is determined whether performance degradation of the application 140 needs to be prevented. When performance degradation of the application 140 needs to be prevented, execution of the measurement command is delayed, and when performance degradation of the application 140 does not need to be prevented, the execution of the measurement command is instructed.

According to the above control, the execution of the detailed measurement can be controlled in consideration of the processing load in accordance with a situation in which the execution of the detailed measurement is requested. Accordingly, performance degradation of the application 140 due to a large processing load caused by the detailed measurement can be prevented.

FIG. 2 shows an outline of processing in which the measurement program 200 monitors a reduction in a service level of the application 140 due to the detailed measurement and changes the control policy when there is a problem in the service level.

After executing the detailed measurement for the application 140, the measurement program 200 checks a measurement result of a service level of the application 140 such as response time or the number of errors, which is measured by a service level monitoring program 201, against an execution history of the detailed measurement, and determines the presence or absence of an application 140 whose service level is reduced during the execution of the detailed measurement. When the application 140 whose service level is reduced is present, the measurement program 200 presents the control level applied to the detailed measurement for the application 140 to an operation manager. The operation manager instructs the measurement program 200 to appropriately change the control level. The measurement program 200 changes the control level according to an instruction from the operation manager.

According to the above control, the operation manager can easily determine whether it is necessary to change the control level, and can change the control level to prevent the service level of the application 140 from being reduced by detailed measurement.

The way of considering the execution control of the detailed measurement differs depending on a company, an operational department, and an application to be handled. Therefore, it is necessary to define a method for controlling execution of detailed measurement for each combination of the type of detailed processing and the situation. The invention also provides a mechanism for easily managing execution control of detailed measurement.

### Embodiment 1

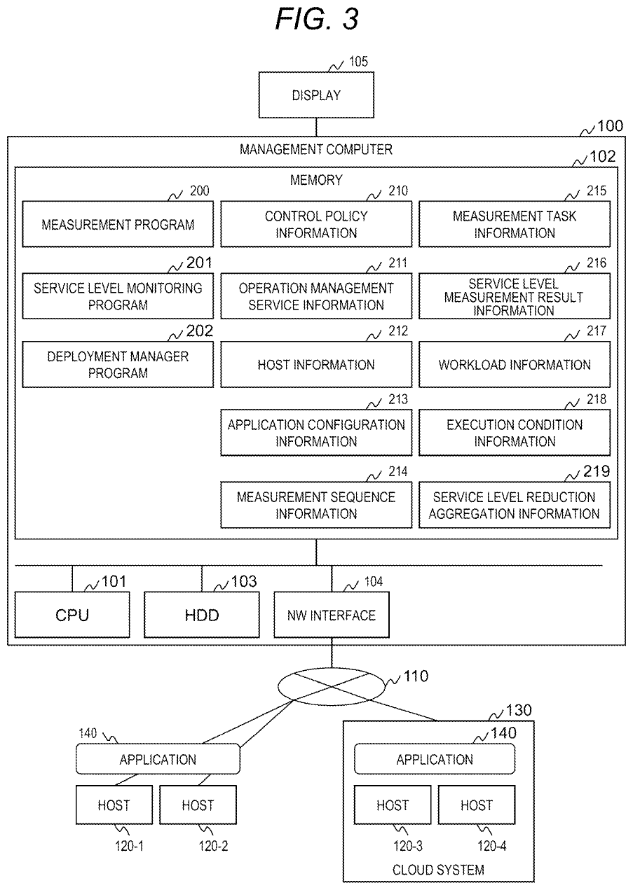

FIG. 3 is a diagram showing an example of a configuration of a system according to Embodiment 1.

The system includes a management computer 100, a plurality of hosts 120, and a cloud system 130. The management computer 100, the plurality of hosts 120, and the cloud system 130 are mutually connected via a network 110 such as a local area network (LAN).

In the present embodiment, an IT system including the plurality of hosts 120 is assumed. The host 120 of the IT system executes processes constituting the application 140. The host 120 may be a physical computer, or may be a virtual computer implemented using a virtualization technique or a node of Kubernetes. The hosts 120-1 and 120-2 are hosts constituting an on-premises IT system, and the hosts 120-3 and 120-4 are hosts constituting the cloud system 130. The invention is not limited to the type of IT systems.

The management computer 100 executes a command for the host 120 for executing processes constituting the application 140 via the network 110, and calls an API. The management computer 100 includes a CPU 101, a memory 102, an HDD 103, and an NW interface 104. A display 105 is connected to the management computer 100.

The CPU 101 executes a program stored in the memory 102. The CPU 101 executes processing according to the program to operate as a functional unit (module) implementing a specific function. In the following description, when processing is described with a program as a subject, it indicates that the CPU 101 is executing the program.

The memory 102 stores a program executed by the CPU 101 and information used by the program. The memory 102 is also used as a work area. The HDD 103 permanently stores data. The NW interface 104 communicates with an external device via the network 110.

The program and the information may be stored in the HDD 103. In this case, the CPU 101 reads the program and the information from the HDD 103, loads the program and the information into the memory 102, and executes the loaded program. The management computer 100 may include a solid state drive (SSD).

The management computer 100 holds the measurement program 200, the service level monitoring program 201, and a deployment manager program 202. The management computer 100 further holds the control policy information 210, operation management service information 211, host information 212, application configuration information 213, measurement sequence information 214, measurement task information 215, service level measurement result information 216, workload information 217, execution condition information 218, and service level reduction aggregation information 219.

The measurement program 200 controls execution of detailed measurement. The service level monitoring program 201 monitors a service level. The deployment manager program 202 deploys the application 140 to the IT system. For example, in order to test a new program, the deployment manager program 202 automates a task of updating the application 140 in the test environment with a new program, a task of updating a part of the applications 140 in the production environment with a new program, a task of updating all the applications 140 in the production environment with a new program little by little, and the like. The service level monitoring program 201 and the deployment manager program 202 are examples of a cooperation program that provides an operation management service related to the application 140.

The functions of the management computer 100 may be implemented using a computer system including a plurality of computers.

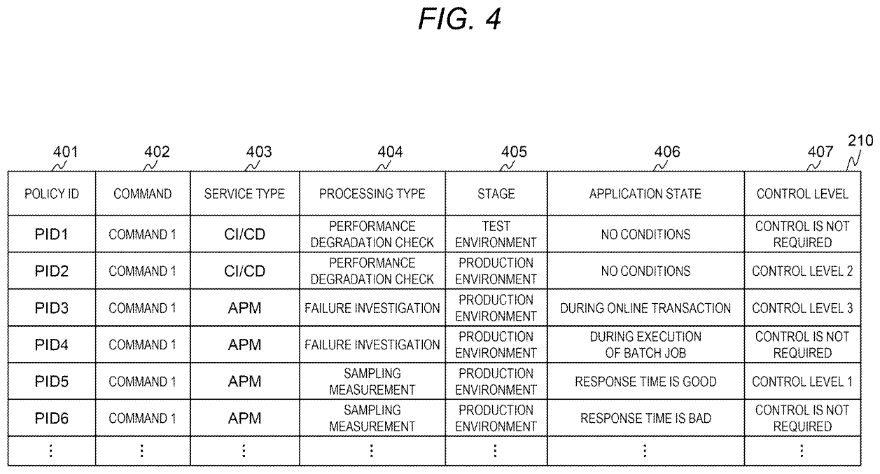

FIG. 4 is a diagram showing an example of a data structure of the control policy information 210 according to Embodiment 1.

The control policy information 210 is information for managing a control policy. Here, the control policy is information defining a control level adapted to a combination of a measurement command and a situation. The control policy information 210 stores entries including a policy ID 401, a command 402, a service type 403, a processing type 404, a stage 405, an application state 406, and a control level 407. One entry is present for one control policy. The field included in the entry is an example, and the entry is not limited to this example.

The policy ID 401 is a field that stores an ID for uniquely identifying a control policy. The command 402 is a field that stores a measurement command executed in detailed measurement.

The service type 403 is a field that stores types of operation management services that request execution of detailed measurement. The processing type 404 is a field that stores types (processing purposes) of detailed measurement requested to be executed by the operation management service. The stage 405 is a field that stores types (stages) of IT systems in which the host 120 to be measured is present. Specifically, when the host 120 present in an IT system in the test environment is subjected to measurement, the “test environment” is stored in the stage 405, and when the host 120 present in an IT system in the production environment is subjected to measurement, the “production environment” is stored in the stage 405. The application state 406 is a field that stores conditions related to states of the application 140 implemented by a process executed by the host 120 to be measured for which detailed measurement is executed. For example, the application state 406 stores items such as “during execution of online transaction processing”, “during execution of batch processing at night”, “response time for the application 140 to process a request is good”, and “response time for the application 140 to process a request is bad”.

The service type 403, the processing type 404, the stage 405, and the application state 406 are a field group that stores values for specifying a situation.

The control level 407 is a field that stores a control level which is an execution condition of a measurement command stored in the command 402. The control level 407 stores “control is not required” or a value representing a control level. A specific execution condition of the control level is managed by the execution condition information 218. A numerical value of the control level is a numerical value representing the control level and corresponds to the degree of reduction of the processing load. The execution of the measurement command is controlled so that the higher the control level is, the larger degree the processing load is reduced. The execution of the measurement command is controlled based on a control level corresponding to a situation.

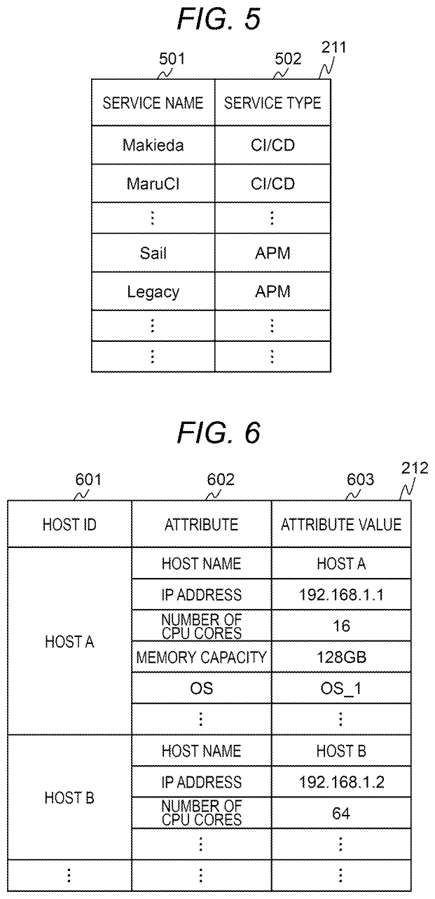

FIG. 5 is a diagram showing an example of a data structure of the operation management service information 211 according to Embodiment 1.

The operation management service information 211 is information for managing an operation management service. The operation management service information 211 stores entries including a service name 501 and a service type 502. One entry is present for one operation management service. The field included in the entry is an example, and the entry is not limited to this example.

The service name 501 is a field that stores a name of an operation management service. The service type 502 is a field that stores a type of an operation management service.

For example, the measurement program 200 refers to the operation management service information 211 to find that a type of an operation management service whose service name is “Makieda” is “CI/CD”. CI/CD is a service type corresponding to the deployment manager program 202, and APM is a service type corresponding to the service level monitoring program 201.

FIG. 6 is a diagram showing an example of a data structure of the host information 212 according to Embodiment 1.

The host information 212 is information for managing the host 120 that executes a process constituting the application 140. The host information 212 stores entries including a host ID 601, an attribute 602, and an attribute value 603. One entry is present for one host 120. The attribute 602 and the attribute value 603 of one entry include rows as many as the number of attributes of a host. The field included in the entry is an example, and the entry is not limited to this example.

The host ID 601 is a field that stores an ID for uniquely identifying the host 120. The attribute 602 is a field that stores a name of an attribute of the host 120. Examples of the attribute include a host name, an IP address, and an OS. The attribute value 603 is a field that stores a value of an attribute.

When the host 120 is implemented using the virtualization technique, a field that stores information of a physical computer and the like may be provided.

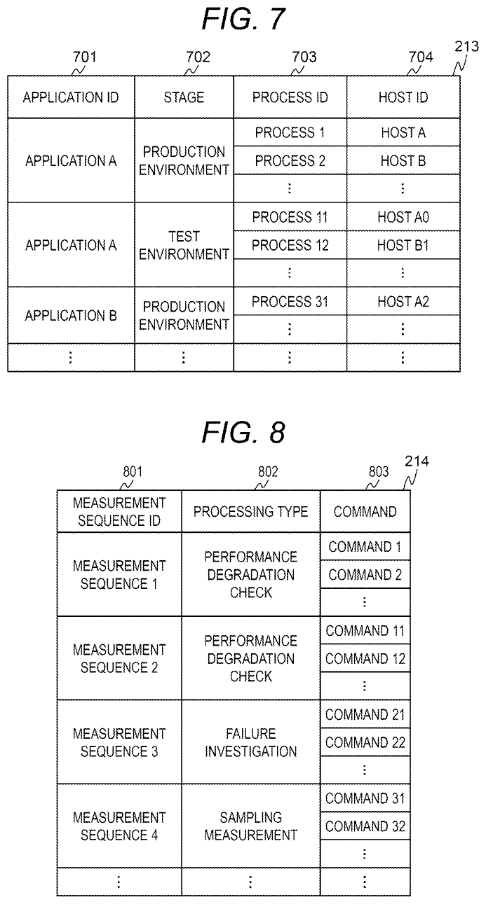

FIG. 7 is a diagram showing an example of a data structure of the application configuration information 213 according to Embodiment 1.

The application configuration information 213 is information for managing the applications 140 running on the IT system. The application configuration information 213 stores entries including an application ID 701, a stage 702, a process ID 703, and a host ID 704. One entry is present for a combination of the application 140 and a stage (IT system). The process ID 703 and the host ID 704 of one entry include rows as many as the number of processes constituting the application 140. The field included in the entry is an example, and the entry is not limited to this example.

The application ID 701 is a field that stores an ID for uniquely identifying the applications 140. The stage 702 is a field that stores a stage of an IT system where the applications 140 run.

The process ID 703 is a field that stores an ID for uniquely identifying a process constituting the application 140. The process ID may be set by a user or may be set by an operating system. The host ID 704 is a field that stores an ID of the host 120 that executes a process. Instead of the host ID 704, a field that stores an IP address may be provided.

In recent years, the number of modes for implementing, using a container technique, the host 120 that executes a process constituting the application 140 has been increased. When the application 140 is implemented using the container technique, an ID of a container instead of an ID of a process may be stored in the process ID 703. In this case, an ID of a node on which the container operates is stored in the host ID 704. A cluster field may be added to the application configuration information 213.

FIG. 8 is a diagram showing an example of a data structure of the measurement sequence information 214 according to Embodiment 1.

The measurement sequence information 214 is information for managing a measurement sequence. Here, the measurement sequence is a sequence of measurement commands constituting detailed measurement. The measurement sequence information 214 stores entries including a measurement sequence ID 801, a processing type 802, and a command 803. One entry is present for one measurement sequence. The command 803 includes rows as many as the number of measurement commands constituting the measurement sequence. The field included in the entry is an example, and the entry is not limited to this example.

The measurement sequence ID 801 is a field that stores an ID for uniquely identifying a measurement sequence. The processing type 802 is a field that stores a type of a measurement sequence (processing purpose). The command 803 is a field that stores measurement commands constituting a measurement sequence.

The measurement program 200 can specify a measurement command constituting a measurement sequence by referring to the measurement sequence information 214 based on an ID of the measurement sequence.

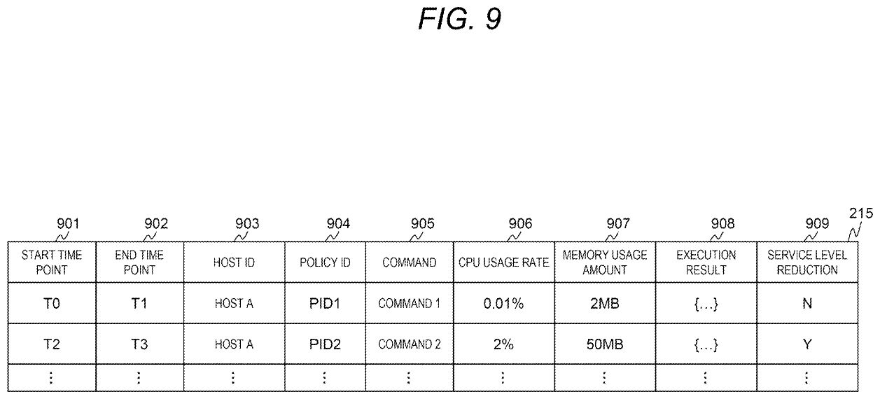

FIG. 9 is a diagram showing an example of a data structure of the measurement task information 215 according to Embodiment 1.

The measurement task information 215 is information for managing a measurement task generated when a measurement command is executed. The measurement task information 215 stores entries including a start time point 901, an end time point 902, a host ID 903, a policy ID 904, a command 905, a CPU usage rate 906, a memory usage amount 907, an execution result 908, and a service level reduction 909. One entry is present for one measurement task. The field included in the entry is an example, and the entry is not limited to this example.

The start time point 901 and the end time point 902 are fields that respectively store a start time point and an end time point of a measurement task. The host ID 903 is a field that stores an ID of the host 120 executing a measurement command. The policy ID 904 is a field that stores an ID of a control policy applied to a measurement command. The command 905 is a field that stores an executed measurement command.

The CPU usage rate 906 and the memory usage amount 907 are fields that respectively store a CPU usage rate and a memory usage amount when a measurement command is executed. For example, an average value, a maximum value, or a minimum value of the CPU usage rates during the period in which a measurement command is executed is stored, and a maximum value of the memory usage amount of a corresponding machine is stored. The execution result 908 is a field that stores a measurement result obtained by executing a measurement command.

The service level reduction 909 is a field that stores a value indicating whether a service level is reduced due to execution of a measurement command. When the service level is not reduced by the execution of the measurement command, “N” is stored in the service level reduction 909, and when the service level is reduced by the execution of the measurement command, “Y” is stored in the service level reduction 909.

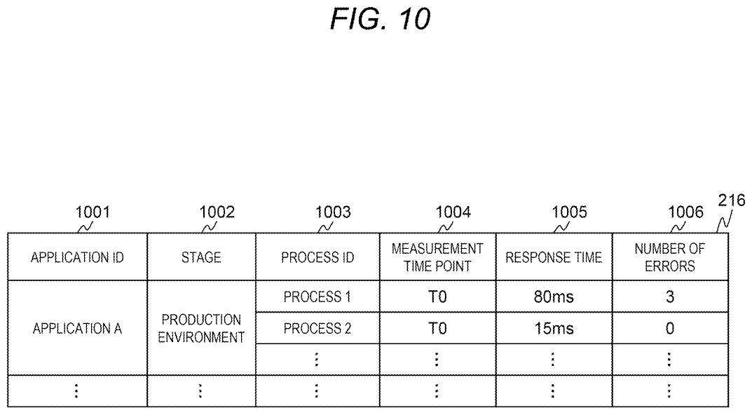

FIG. 10 is a diagram showing an example of a data structure of the service level measurement result information 216 according to Embodiment 1.

The service level measurement result information 216 is information for managing a measurement result of an evaluation index of a service level of the application 140. The evaluation index of the service level of the application 140 is, for example, response time or the number of errors per unit time.

The evaluation index of the service level of the application 140 is measured by the service level monitoring program 201. The service level monitoring program 201 measures an evaluation index of a service level such as the response time and the number of errors, and stores the measurement result in the service level measurement result information 216.

In the case of the application 140 including a plurality of processes (for example, in the case of including a plurality of Web servers and database servers), an evaluation index of a service level is measured for each process.

The service level measurement result information 216 stores entries including an application ID 1001, a stage 1002, a process ID 1003, a measurement time point 1004, a response time 1005, and a number of errors 1006. One entry is present for one measurement result. The field included in the entry is an example, and the entry is not limited to this example.

The application ID 1001 is a field that stores an ID of the application 140. The stage 1002 is a field that stores a stage of an IT system. The process ID 1003 is a field that stores an ID of a process for which a service level is measured. The measurement time point 1004 is a field that stores a time point when an evaluation index of a service level is measured.

The response time 1005 and the number of errors 1006 are fields that store the response time and the number of errors measured as the evaluation index of the service level.

The evaluation index of the service level may be other than the response time and the number of errors. For example, the evaluation index may be a maximum value of the response time during a measurement period or 99%-tile.

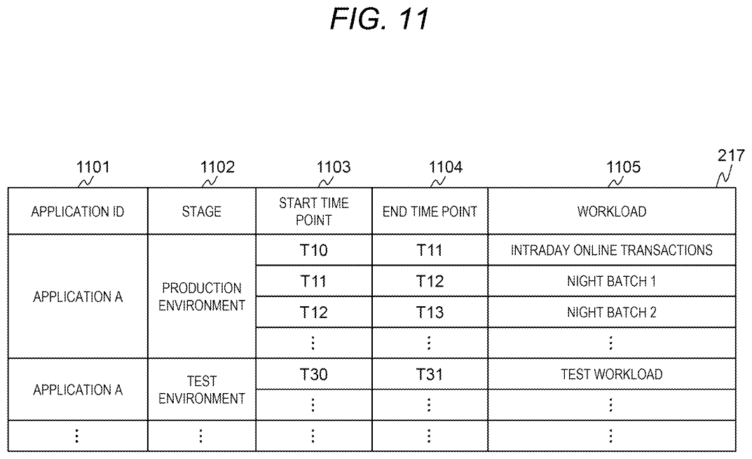

FIG. 11 is a diagram showing an example of a data structure of the workload information 217 according to Embodiment 1.

The workload information 217 is information for managing a workload executed by the application 140. The workload information 217 stores entries including an application ID 1101, a stage 1102, a start time point 1103, an end time point 1104, and a workload 1105. One entry is present for a combination of the application 140 and the IT system. The field included in the entry is an example, and the entry is not limited to this example.

The application ID 1101 is a field that stores an ID for uniquely identifying the applications 140. The stage 1102 is a field that stores a stage of an IT system.

The workload 1105 is a field that stores a name of a workload executed by the application 140. The start time point 1103 and the end time point 1104 are fields that store a start time point and an end time point of a workload.

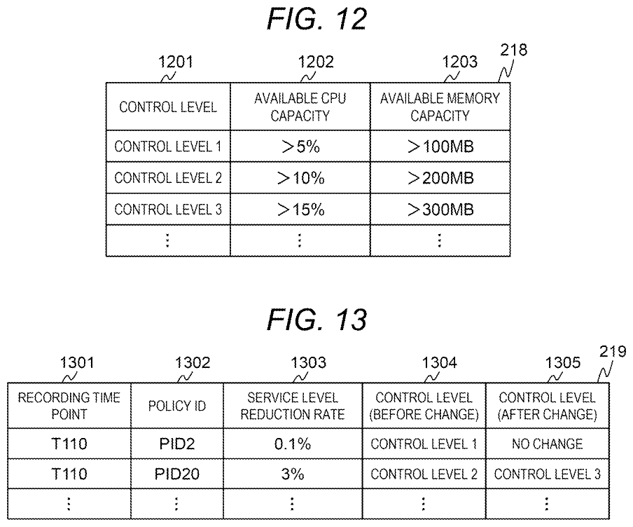

FIG. 12 is a diagram showing an example of a data structure of the execution condition information 218 according to Embodiment 1.

The execution condition information 218 is information for managing an execution condition which is a content of execution control of a measurement command. The measurement program 200 suspends the execution of the measurement command when the execution condition is not satisfied, and executes the measurement command when the execution condition of the measurement command is satisfied.

The execution condition information 218 stores entries including a control level 1201, an available CPU capacity 1202, and an available memory capacity 1203. One entry is present for one control level. The field included in the entry is an example, and the entry is not limited to this example.

The control level 1201 is a field that stores a value indicating a control level. The available CPU capacity 1202 and the available memory capacity 1203 are fields that store conditional expressions of the available capacity of a CPU and the available capacity of a memory that are execution conditions of a measurement command.

The measurement command is executed when a control level in which the control level 1201 is “control level 1” is adopted, that is, when the available CPU capacity of the host 120 is larger than 5% and the available memory capacity thereof is larger than 100 MB. The available CPU capacity 1202 may store, instead of the available capacity of the CPU, a conditional expression using a value calculated using a mathematical expression. For example, a conditional expression related to a value obtained by multiplying the “number of CPU cores” by “1%” may be stored. The same applies to the available memory capacity 1203.

The available capacity of the CPU and the available capacity of the memory are an example of the execution condition, and the execution condition is not limited to this example. For example, a conditional expression related to the number of I/Os and the response time measured in the measurement of the service level may be set as an execution condition.

The execution condition corresponding to the control level is managed independently of the control level. Therefore, the execution condition can be appropriately changed. It is easy to set and change execution conditions for a control policy.

FIG. 13 is a diagram showing an example of a data structure of the service level reduction aggregation information 219 according to Embodiment 1.

The service level reduction aggregation information 219 is information obtained by aggregating results of a reduction in a service level due to control of detailed measurement according to a control policy. The service level reduction aggregation information 219 stores entries including a recording time point 1301, a policy ID 1302, a service level reduction rate 1303, a control level (before change) 1304, and a control level (after change) 1305. One entry is present for a combination of a control level and a recording time point. The field included in the entry is an example, and the entry is not limited to this example.

The recording time point 1301 is a field that stores a time point at which a reduction rate of the service level is calculated. The policy ID 1302 is a field that stores an ID of a control policy. The service level reduction rate 1303 is a field that stores a service level reduction rate indicating a degree of reduction in a service level.

The control level (before change) 1304 is a field that stores a control level set for a control policy. The control level (after change) 1305 is a field that stores an update result of the control level set in the control policy.

The processing executed by the management computer 100 according to Embodiment 1 will be described below.

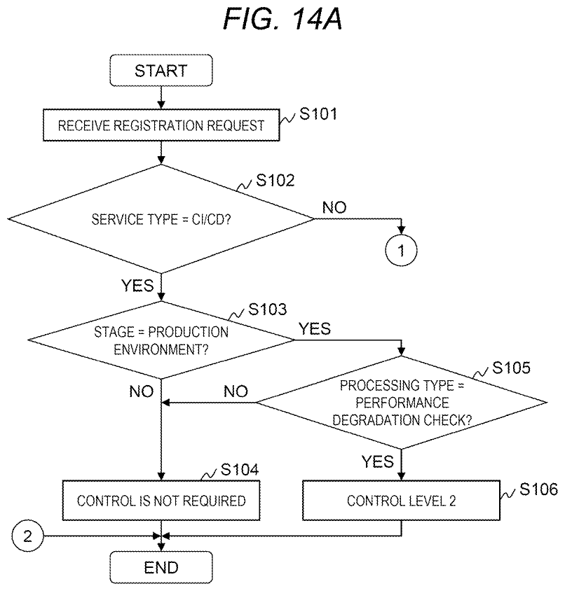

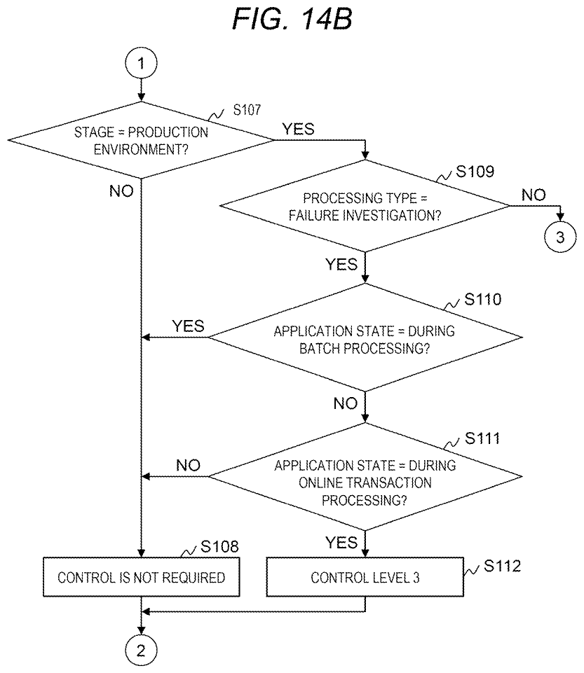

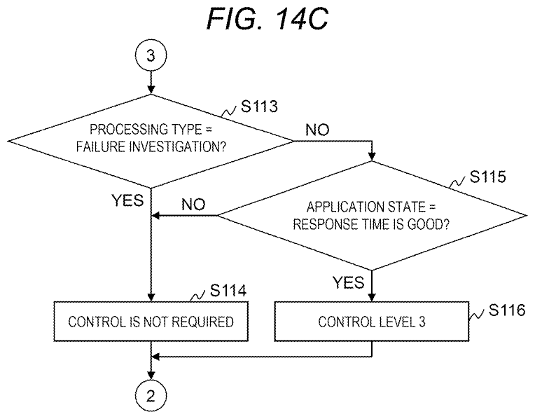

First, a method for setting a control policy will be described. FIGS. 14A, 14B, and 14C are flowcharts showing an example of control policy setting processing executed by the measurement program 200 according to Embodiment 1.

The measurement program 200 receives a registration request including a measurement command, a service type, a processing type, a stage, and an application state (step S101).

The measurement program 200 adds entries to the control policy information 210, and sets an ID of a control policy in the policy ID 401 of the added entries. The measurement program 200 sets values included in the registration request in the command 402, the service type 403, the processing type 404, the stage 405, and the application state 406 of the added entries.

When a name of a service is included in the registration request instead of the service type, the measurement program 200 specifies a service type by referring to the operation management service information 211.

The measurement program 200 determines whether the service type is CI/CD (step S102).

When the service type is CI/CD, the measurement program 200 determines whether a stage is a production environment (step S103).

When the stage is not a production environment, that is, when the stage is a test environment, the measurement program 200 sets “control is not required” as a control level (step S104), and ends the control policy setting processing. In the test environment, the performance degradation of the application 140 is not a problem in many cases, and therefore, control is not performed for the execution of the detailed measurement.

When the stage is a production environment, the measurement program 200 determines whether the processing type is a performance degradation check (step S105). In the performance degradation check, a result of detailed measurement performed before the update and a result of detailed measurement performed after the update are compared with each other, and, for example, the presence or absence of a function that is significantly slowed down and the presence or absence of a process having a significantly reduced page cache hit rate are checked.

For detailed measurement with a large load executed in the production environment, a high control level is set so that the performance of the application 140 does not degrade.

When the processing type is not the performance degradation check, the measurement program 200 sets “control is not required” as the control level (step S104), and ends the control policy setting processing.

When the processing type is performance and grade check, the measurement program 200 sets “control level 2” as the control level (step S106), and ends the control policy setting processing.

When the service type is not CI/CD, that is, when the service type is APM in step S202, the measurement program 200 determines whether the stage is a production environment (step S107).

When the stage is not a production environment, that is, when the stage is a test environment, the measurement program 200 sets “control is not required” as the control level (step S108), and ends the control policy setting processing.

When the stage is a production environment, the measurement program 200 determines whether the processing type is “failure investigation” (step S109). The failure investigation is performed to investigate the cause in detail when the occurrence of a failure in the application 140 is detected by the service level monitoring program 201. The service level monitoring program 201 determines that a failure occurs when a large number of errors are measured in a short period or when the response time is increased to several times normal time.

When it is determined that the processing type is “failure investigation”, the measurement program 200 determines whether the application state is batch processing (step S110).

When the application state is the batch processing, the measurement program 200 sets “control is not required” as the control level (step S108), and ends the control policy setting processing. In the batch processing, the high-load state continues for a long time, and therefore, the effect of reducing a load by adjusting an execution timing of a measurement program is low. The purpose of the failure investigation is a cause investigation of the high-load state, and therefore, it is not necessary to control the detailed measurement.

When the application state is not the batch processing, the measurement program 200 determines whether the application state is during online transaction processing (step S111).

When the application state is not during the online transaction processing, the measurement program 200 sets “control is not required” as the control level (step S108), and ends the control policy setting processing.

When the application state is during the online transaction processing, the measurement program 200 sets “control level 3” as the control level (step S112), and ends the control policy setting processing. Generally, when the application 140 performs detailed measurement during the processing of the online transaction, a high control level is set for reducing the response time of the application 140.

When it is determined in step S209 that the processing type is not “failure investigation”, the measurement program 200 determines whether the processing type is sampling measurement (step S113). The sampling measurement is performed to acquire sample information to be used for future failure investigation when the service level does not deteriorate, or when slight deterioration occurs but no abnormality is observed.

When the processing type is not sampling measurement, the measurement program 200 sets “control is not required” as the control level (step S114), and ends the control policy setting processing.

When the processing type is sampling measurement, it is determined whether the application state is “response time is good” (step S115).

When the application state is not “response time is good”, that is, when the application state is “response time is bad”, the measurement program 200 sets “control is not required” as the control level (step S114), and ends the control policy setting processing.

When the response time is bad, it is important to specify a cause of the deterioration in the response time. Therefore, “control is not required” is set as the control level to immediately execute the detailed measurement.

When the application state is “response time is good”, the measurement program 200 sets “control level 1” as the control level (step S116), and ends the control policy setting processing.

When the response time is good, the purpose is to acquire sample data for comparison in the future failure occurrence. Therefore, it is necessary to control detailed measurement so that the processing performance of the application 140 does not degrade. On the other hand, the processing load of the sampling measurement is not so high, and therefore, a low control level is set.

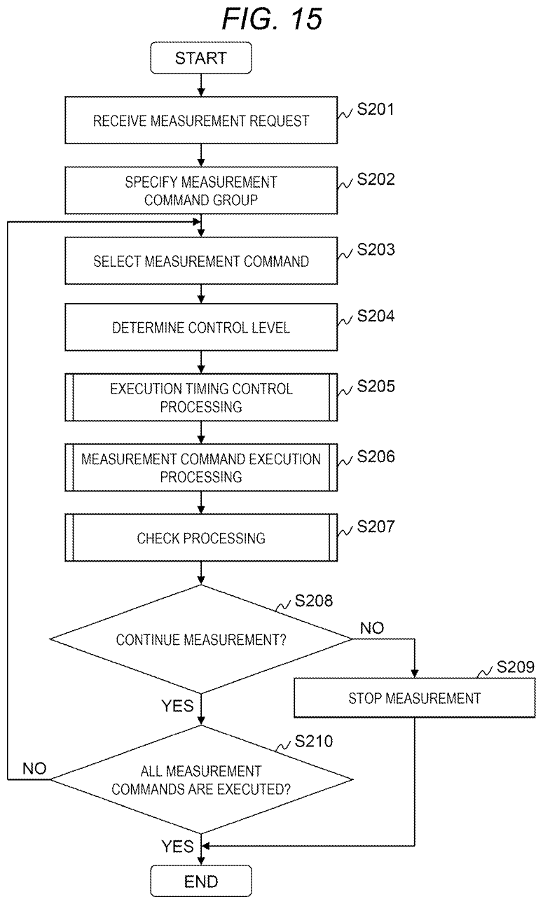

Next, control of the detailed measurement will be described. FIG. 15 is a flowchart showing an example of processing executed by the measurement program 200 according to Embodiment 1.

The service level monitoring program 201 transmits a measurement request to the measurement program 200 when a reduction in the service level of the application 140 is detected. When the response time is monitored as the service level, the delay of the response time is detected as a reduction in the service level. When the application 140 is deployed to an IT system, the deployment manager program 202 transmits a measurement request to the measurement program 200.

When the measurement request is received from a cooperation program, the measurement program 200 controls the execution of the detailed measurement based on a control level of a measurement command included in the detailed measurement corresponding to the measurement request. Detailed processing will be described below.

The measurement program 200 receives the measurement request from the cooperation program (step S201). The measurement request includes a name of a service provided by the cooperation program of a calling source, an ID of a measurement sequence corresponding to the measurement processing to be executed, an ID of the application 140 to be measured, information of an IT system (stage) where the application 140 runs, an ID of the host 120 to be measured, and the like.

The measurement program 200 specifies a measurement command group constituting the measurement sequence by referring to the measurement sequence information 214 based on the ID of the measurement sequence (step S202).

Specifically, the measurement program 200 searches for an entry in which the ID of the measurement sequence is stored in the measurement sequence ID 801, and acquires the measurement command group stored in the command 803 of the searched entry. The measurement program 200 registers the measurement command group in an execution list.

The measurement program 200 selects one measurement command from the execution list (step S203). Measurement commands are selected in an order of execution of the measurement commands.

The measurement program 200 determines a control level by referring to the control policy information 210 based on values included in the measurement request (step S204).

Specifically, the measurement program 200 searches for an entry (control policy) in which the selected measurement program is stored in the command 402 and the values corresponding to the current situation are stored in the service type 403, the processing type 404, the stage 405, and the application state 406. The measurement program 200 acquires a value in the control level 407 of the searched entry.

The service type of the cooperation program can be specified by referring to the operation management service information 211 based on the name of the service. The type of the detailed measurement can be specified by referring to the measurement sequence information 214 based on the ID of the measurement sequence. The service level of the application 140 can be specified by referring to the service level measurement result information 216 based on the ID of the application 140. The execution state of the workload of the application 140 can be specified by referring to the workload information 217 based on the ID of the application 140.

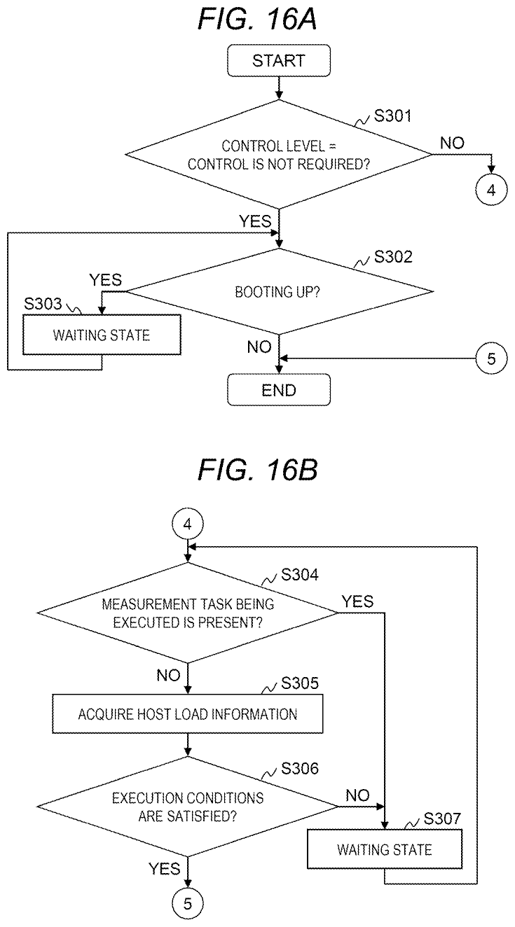

The measurement program 200 executes measurement command execution timing control processing based on the determined control level (step S205). Details of the measurement command execution timing control processing will be described with reference to FIGS. 16A and 16B.

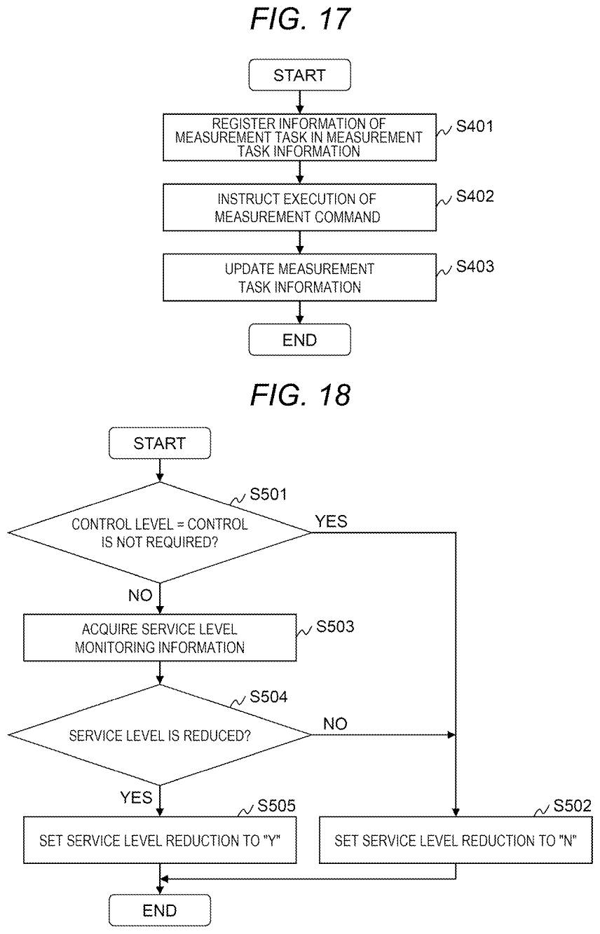

When it is determined that the measurement command can be executed in the measurement command execution timing control processing, the measurement program 200 executes the measurement command execution processing (step S206). Details of the detailed command execution processing will be described with reference to FIG. 17.

The measurement program 200 executes check processing for checking a service level of the application (step S207). Details of the check processing will be described with reference to FIG. 18.

The measurement program 200 determines whether to continue the detailed measurement based on a result of the check processing (step S208). Specifically, when there is no problem in the service level of the application 140, the detailed measurement is continued, and when there is a problem in the service level of the application 140, the detailed measurement is stopped.

When it is determined not to continue the detailed measurement because there is a problem in the service level of the application 140, the measurement program 200 transmits a measurement stop error due to the occurrence of the problem in the service level to the cooperation program of the calling source (step S209), and ends the processing. The measurement program 200 may proceed to step S209 after a certain period of time has elapsed.

When it is determined to continue the detailed measurement because there is no problem in the service level of the application 140, the measurement program 200 determines whether a measurement command is present in the execution list (step S210).

When the measurement command is present in the execution list, the measurement program 200 returns to step S203 and executes the same processing. When the measurement command is not present in the execution list, the measurement program 200 transmits a measurement completion notification to the cooperation program of the calling source, and ends the processing.

FIGS. 16A and 16B are flowcharts showing an example of execution timing control processing of the detailed measurement executed by the measurement program 200 according to Embodiment 1.

The measurement program 200 receives the information and the control level of the target host 120 as inputs, and starts the execution timing control processing of the detailed measurement. In this processing, the measurement program 200 controls an execution timing of a detailed command based on the determined control level. Details of the processing will be described below.

The measurement program 200 determines whether the control level is “control is not required” (step S301).

When the control level is “control is not required”, the measurement program 200 determines whether the target host 120 is booting up (step S302). Even if the measurement command is executed when the target host 120 is booting up, useful information cannot be obtained, and thus the execution timing of the measurement command is adjusted.

When the target host 120 is booting up, the measurement program 200 shifts to a waiting state (step S303), and returns to step S302 after a certain period of time has elapsed. The waiting time may be set according to the number of transitions to the waiting state. For example, a method for setting a waiting time obtained by multiplying the number of waiting times by 10 seconds is conceivable. A maximum value may be set for the number of transitions to the waiting state, and when the number of transitions to the waiting time is larger than the maximum value, the measurement program 200 may return an error to the cooperation program.

When the target host 120 is not booting up, the measurement program 200 determines that the measurement command can be executed, and ends the execution timing control processing.

When the control level is not “control is not required”, the measurement program 200 determines whether a measurement task being executed is present in the target host 120 by referring to the measurement task information 215 (step S304).

When the measurement task being executed is present in the target host 120, the measurement program 200 shifts to a waiting state (step S307), and returns to step S304 after a certain period of time has elapsed. The waiting time may be set according to the number of transitions to the waiting state. For example, a method for setting a waiting time obtained by multiplying the number of waiting times by 10 seconds is conceivable. A maximum value may be set for the number of transitions to the waiting state, and when the number of transitions to the waiting time is larger than the maximum value, the measurement program 200 may return an error to the cooperation program.

When the measurement task being executed is not present in the target host 120, the measurement program 200 acquires load information from the target host 120 (step S305).

The measurement program 200 determines, based on a load state of the target host 120, whether an execution condition corresponding to the control level is satisfied (step S306).

When the execution condition is not satisfied, the measurement program 200 proceeds to step S307. When the execution condition is satisfied, the measurement program 200 determines that the measurement command can be executed, and ends the execution timing control processing.

FIG. 17 is a flowchart showing the measurement command execution processing executed by the measurement program 200 according to Embodiment 1.

The measurement program 200 receives the information of the target host 120, the control policy, and the measurement command as inputs, and starts the measurement command execution processing. In the measurement command execution processing, the measurement program 200 instructs the target host to execute the measurement command and acquires a measurement result. Details of the processing will be described below.

The measurement program 200 registers information of the measurement task in the measurement task information 215 (step S401).

Specifically, the measurement program 200 adds an entry to the measurement task information 215. The measurement program 200 sets an ID of the target host 120, an ID of the control policy, and the measurement command in the host ID 903, the policy ID 904, and the command 905 of the added entry.

The measurement program 200 instructs the target host 120 to execute the measurement command (step S402).

Specifically, the measurement program 200 connects to the target host 120 using secure shell (SSH) and instructs the target host 120 to execute the measurement command. The measurement program 200 acquires an execution result from the target host 120.

An instruction causing the target host 120 to execute the measurement command may be a method other than SSH. For example, execution of the measurement command may be instructed by calling an API disclosed by the host 120.

At this time, the measurement program 200 measures a processing load of the target host 120 that executes the measurement command.

The measurement program 200 updates the measurement task information 215 based on the measurement result and the information of the processing load, and then ends the measurement command execution processing (step S403).

Specifically, the measurement program 200 respectively stores a time point at which the target host 120 is instructed to execute the measurement command and a time point at which the measurement result is acquired in the start time point 901 and the end time point 902 of the entry added in step S401. The measurement program 200 stores the measurement result in the execution result 908 of the entry, and stores values in the CPU usage rate 906 and the memory usage amount 907 of the entry based on the information of the processing load.

The measurement program 200 may register the acquired execution result as it is, or may register an execution result converted based on a predetermined rule. For example, the acquired execution result is converted into structured data in a table format or the like.

FIG. 18 is a flowchart showing an example of check processing executed by the measurement program 200 according to Embodiment 1.

The measurement program 200 receives the entry (additional entry) added to the measurement task information 215 as an input, and starts check processing. In the check processing, it is determined whether the service level of the application 140 is reduced by the execution of the measurement command. Details of the processing will be described below.

The measurement program 200 determines whether a control level of the measurement task is “control is not required” (step S501).

Specifically, the measurement program 200 searches for an entry in which a value in the policy ID 401 matches a value in the policy ID 904 of the additional entry by referring to the control policy information 210. The measurement program 200 determines whether the control level 407 of the searched entry is “control is not required”.

When the control level of the measurement task is “control is not required”, the measurement program 200 determines that it is required to stop the measurement, and sets “N” in the service level reduction 909 of the additional entry (step S502). Thereafter, the measurement program 200 ends the check processing.

When the control level of the measurement task is not “control is not required”, the measurement program 200 acquires, by referring to the service level measurement result information 216, the information of monitoring a service level of an application 140 including the processes executed by the target host (step S503). Specifically, the following processing is executed.

(S503-1) The measurement program 200 calculates an execution period of the measurement command based on the start time point 901 and the end time point 902 of the additional entry.

(S503-2) The measurement program 200 refers to the application configuration information 213 to specify an application 140 including the processes executed by the target host and an IT system (stage) where the application 140 runs.

(S503-3) The measurement program 200 refers to the service level measurement result information 216 to search for a row in which a time point stored in the measurement time point 1004 is included in the execution period of the measurement command, the values in the application ID 1001 and the stage 1002 match the application 140 and the IT system specified in S503-2, and an ID of a process executed by the target host is stored in the process ID 1003.

(S503-4) The measurement program 200 acquires the response time 1005 and the number of errors 1006 of the searched row as the service level monitoring information.

The above is the description of the processing of step S503.

The measurement program 200 evaluates the service level based on the service level monitoring information, and determines, based on the evaluation result, whether the service level is reduced (step S504). For example, the following processing is conceivable.

(S504-1) The measurement program 200 calculates the number of rows in which a value in the response time 1005 is larger than a threshold (for example, 100 ms), the number of rows in which a value in the number of errors 1006 is larger than 0, or the number of rows in which a value in the response time 1005 is larger than a predetermined value and a value in the number of errors 1006 is larger than 0. As the threshold for the response time 1005, 90%-tile of a response time in a certain period before a time point at which the measurement command is transmitted may be adopted.

(S504-2) The measurement program 200 divides the calculated number of rows by the number of rows searched in step S503.

(S504-3) The measurement program 200 determines whether the calculated value is larger than a threshold (for example, 5%). When the calculated value is larger than the threshold, the measurement program 200 determines that the service level is reduced.

When the service level is not reduced, the measurement program 200 proceeds to step S502.

When the service level is reduced, the measurement program 200 determines that it is necessary to stop the detailed measurement, and sets “Y” in the service level reduction 909 of the additional entry (step S505). Thereafter, the measurement program 200 ends the check processing.

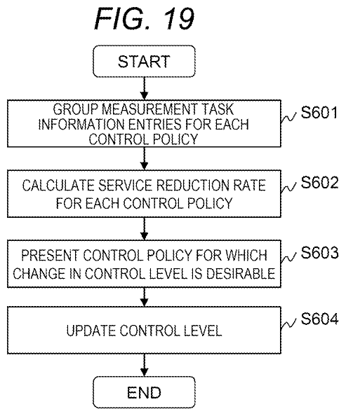

FIG. 19 is a flowchart showing an example of control level update processing executed by the measurement program 200 according to Embodiment 1.

In the control level update processing, the measurement program 200 presents a control policy requiring an update of the control level to the operation manager, and receives an instruction to update the control level from the user. Detailed processing will be described below.

The measurement program 200 groups entries of the measurement task information 215 for each control policy (step S601).

Specifically, the measurement program 200 groups entries of the measurement task information 215 which have the same policy ID 904 value.

The measurement program 200 calculates a service level reduction rate of each control policy (step S602).

Specifically, the measurement program 200 calculates, as the service level reduction rate, a value obtained by dividing the number of entries in which the service level reduction 909 is “Y” among entries included in the group of the control policy by the number of all the entries in the group of the control policy.

At this time, the measurement program 200 adds entries as many as the number of control policies to the service level reduction aggregation information 219. The measurement program 200 sets a current time point in the recording time point 1301 of each added entry, and sets an ID of the control policy in the policy ID 1302. The measurement program 200 sets a control level set for a control policy to the control level (before change) 1304 of each added entry. The control level can be acquired by referring to the control policy information 210 based on an ID of a control policy. The measurement program 200 sets a calculated service level reduction rate in the service level reduction rate 1303 of each added entry.

The measurement program 200 presents a control policy for which it is desirable to change the control level to the user based on the service level reduction rate (step S603). For example, a control policy in which a service level reduction rate is larger than a threshold is presented to the user. The detailed contents of the control policy acquired from the control policy information 210 and the service level reduction rate are presented to the user.

At this time, the measurement program 200 sets “no change” to the control level (after change) 1305 of the entry of the service level reduction aggregation information 219 corresponding to the control policy not presented to the user.

The user determines, based on the presented information, whether the control level set in the control policy can be updated. When updating the control level, the user transmits an update instruction including the ID of the control policy and the control level to the measurement program 200. For example, for a control policy in which a service level reduction rate is larger than 5%, an operation of increasing the control level is performed. Accordingly, a reduction in the service level is prevented.

When the update instruction is received, the measurement program 200 updates the control level of the control policy (step S604), and then ends the control level update processing.

Specifically, the measurement program 200 sets a control level after change to the control level (after change) 1305 of the entry of the service level reduction aggregation information 219 corresponding to a control policy that is a target instructed to be changed. The measurement program 200 also sets the changed control level in the control level 407 of the entry of the control policy information 210 corresponding to the control policy that is a target instructed to be changed.

Note that “no change” is set to the control level (after change) 1305 of the entry of the service level reduction aggregation information 219 corresponding to a control policy which is presented to the user but a control level of which is not updated.

According to the present embodiment, the measurement program 200 can control the execution of the detailed measurement based on the control policy. Accordingly, performance degradation of the application due to execution of the detailed measurement can be prevented. Flexible and detailed control can be implemented by controlling execution for each measurement command constituting the detailed measurement.

According to the present embodiment, an execution condition of the measurement command constituting the detailed measurement is managed separately from the control policy, and therefore, the execution condition of the measurement command in the control policy can be easily set and changed. The setting cost can be reduced by setting the execution condition for the measurement command.

According to the present embodiment, the operation manager can change the execution condition of the control policy by grasping, based on the formation presentation of the measurement program 200, the control policy in which the service level is reduced.

The invention is not limited to the above-described embodiments, and includes various modifications. For example, the above-described embodiments are described in detail in order to describe the invention in an easy-to-understand manner, and the invention is not necessarily limited to those including all the described configurations. A part of a configuration in each embodiment may be added to, deleted from, or replaced with another configuration.

A part or all of configurations, functions, processing units, processing methods, and the like described above may be implemented by hardware by, for example, designing with an integrated circuit. The invention can also be implemented by a program code of software for implementing the functions in the embodiments. In this case, a storage medium storing the program code is provided to a computer, and a processor provided in the computer reads the program code stored in the storage medium. In this case, the program code read from the storage medium implements the functions of the embodiments described above by itself, and the program code itself and the storage medium storing the program code constitute the invention. Examples of the storage medium for supplying such a program code include a flexible disk, a CD-ROM, a DVD-ROM, a hard disk, a solid state drive (SSD), an optical disk, a magneto-optical disk, a CD-R, a magnetic tape, a nonvolatile memory card, and a ROM.

Further, the program code for implementing the functions described in the present embodiments can be implemented in a wide range of programs or script languages such as assembler, C/C++, Perl, Shell, PHP, Python, and Java (registered trademark).

Further, the program code of the software for implementing the functions in the embodiments may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are illustrated in the embodiments described above, and not all control lines and information lines in a product are necessarily illustrated. All the configurations may be connected to one another.

What is claimed is:

1. A control system connected to a computer system including a plurality of computers, wherein
one or more hosts configured to execute processes constituting an application run in the computer system, and
the control system
manages a control policy for controlling, according to a load state of the host, execution of measurement processing for acquiring internal information on the host,
determines a control policy to be applied when a measurement request is received, and
controls, based on the determined control policy and the load state of the host to be measured, execution of the measurement processing for the host to be measured.

2. The control system according to claim 1, wherein
the measurement processing is processing including a plurality of measurement commands,
the control policy is data in which the measurement command, information indicating a situation in which the measurement command is executed, and an execution condition are associated with one another,
the measurement request includes information for specifying the situation, and
the control system
selects one of the measurement commands,
determines, based on the information for specifying the situation included in the received measurement request, the control policy to be applied to the selected measurement command,
determines whether the selected measurement command is executable for the host to be measured based on the execution condition of the determined control policy and the load state of the host to be measured.

3. The control system according to claim 2, wherein the control system
determines whether another measurement command is being executed in the host to be measured, and
determines whether the selected measurement command is executable for the host to be measured based on the determined control policy and the load state of the host to be measured after the other measurement command is completed when the other measurement command is being executed in the host to be measured.

4. The control system according to claim 2, wherein
when the measurement processing is executed, an evaluation index related to a service level of the application including the processes executed by the host to be measured is measured, and a history in which the control policy applied to the measurement processing and the evaluation index are associated with each other is recorded, a control policy in which the service level of the application is reduced is specified based on the history, and
information on the specified control policy is presented.

5. The control system according to claim 2, wherein
the information indicating the situation includes a transmission source of the measurement request, a type of the measurement processing, a type of a computer system where the host runs, and a running state of the application.

6. The control system according to claim 5, wherein
the running state of the application includes a state in which at least one of batch processing and online transaction processing is executed.

7. A method for controlling measurement processing, the method being executed by a control system connected to a computer system including a plurality of computers, one or more hosts configured to execute processes constituting an application running in the computer system, the control system managing a control policy for controlling, according to a load state of the host, execution of measurement processing for acquiring internal information on the host, the method comprising: by the control system,
a first step of determining a control policy to be applied when a measurement request is received; and
a second step of controlling, based on the determined control policy and the load state of the host to be measured, execution of the measurement processing for the host to be measured.

8. The method for controlling measurement processing according to claim 7, wherein
the measurement processing is processing including a plurality of measurement commands,
the control policy is data in which the measurement command, information indicating a situation in which the measurement command is executed, and an execution condition are associated with one another,
the measurement request includes information for specifying the situation, and
the first step includes, by the control system,
a step of selecting one of the measurement commands,
a step of determining, based on the information for specifying the situation included in the received measurement request, the control policy to be applied to the selected measurement command, and
a step of determining whether the selected measurement command is executable for the host to be measured based on the execution condition of the determined control policy and the load state of the host to be measured.

9. The method for controlling measurement processing according to claim 8, wherein
the second step includes, by the control system, a step of determining whether another measurement command is being executed in the host to be measured, and a step of determining whether the selected measurement command is executable for the host to be measured based on the determined control policy and the load state of the host to be measured after the other measurement command is completed when the other measurement command is being executed in the host to be measured.

10. The method for controlling measurement processing according to claim 8, the method comprising: by the control system,
a step of, when the measurement processing is executed, measuring an evaluation index related to a service level of the application including the process executed by the host to be measured, and recording a history in which the control policy applied to the measurement processing and the evaluation index are associated with each other;
a step of specifying, based on the history, a control policy in which the service level of the application is reduced; and
a step of presenting information on the specified control policy.

11. The method for controlling measurement processing according to claim 8, wherein
the information indicating the situation includes a transmission source of the measurement request, a type of the measurement processing, a type of a computer system where the host runs, and a running state of the application.

12. The method for controlling measurement processing according to claim 11, wherein
the running state of the application includes a state in which at least one of batch processing and online transaction processing is executed.
